(19) United States
(12) Patent Application Publication
(10) Pub. No.: US 2024/0254379 A1
(43) Pub. Date: Aug. 1, 2024

(54) THERMALLY CONDUCTIVE POLYMER COMPOSITION AND ARTICLES MADE THEREFROM

(71) Applicant: Solvay Specialty Polymers USA, LLC, Alpharetta, GA (US)

(72) Inventor: Emmanuel ANIM-DANSO, Sandy Springs, GA (US)

(21) Appl. No.: 18/579,966

(22) PCT Filed: Jul. 12, 2022
(86) PCT No.: PCT/EP2022/069463

§ 371 Date: Jan. 17, 2024

Related U.S. Application Data
(60) Provisional application No. 63/225,626, filed on Jul. 26, 2021.

(51) Int. Cl. C09K 5/14; C08K 3/22; C08K 3/38; C08K 7/06; C08K 13/04; C08L 77/00; C08L 81/02

(52) U.S. Cl. CPC C09K 5/14; C08K 13/04; C08L 77/00; C08L 81/02; C08K 2003/222; C08K 2003/2296; C08K 2003/385; C08K 7/06; C08K 2201/001; C08K 2201/014

(57) ABSTRACT

Polymer compositions are provided, and articles made therefrom. The polymer compositions comprise from 25 to 50 wt. % of a thermoplastic polymer; from 10 to 45 wt. % of a thermally conductive filler; from 15 to 30 wt. % of a carbon fiber; from 2 to 8 wt. % of a toughener; and less than 5 wt. % additives. The polymer composition is substantially free of glass fibers. The polymer compositions described herein surprisingly exhibit significantly improved thermal conductivity relative to analogous polymer compositions not comprising the toughener and/or in which the carbon fiber is replaced by glass fiber.

### CROSS-REFERENCE TO RELATED APPLICATION

This application claims priority to US Provisional application filed on 26 Jul. 2021 with No. 63/225,626, the whole content of this application being incorporated herein by reference for all purposes.

### TECHNICAL FIELD

Polymer compositions are provided that have advantageous mechanical properties while also being thermally conductive. Articles made therefrom are also provided. In particular, the present polymer compositions comprise a thermoplastic polymer and a combination of a thermally conductive filler, a carbon fiber and a toughener.

### BACKGROUND

Polymer compositions are used in many applications, including in motors, batteries, LED's, electronic circuit boards, etc. In many of these, the polymer composition may desirably function to help dissipate heat away from any heat generating component. Polymer compositions used in such applications also desirably have mechanical properties and/or dimensional stability that allow them to perform consistently through multiple heat cycles.

Purely thermally conductive fillers have typically been used in polymer compositions intended for use in these environments. However, polymer compositions including only thermally conductive fillers have limited in- and through-plane thermal conductivity. This may be due to thermal conductivity limitations intrinsic to the filler(s) and/or thermal resistance at polymer/filler interfaces. As a result, the use of higher concentrations of purely thermally conductive fillers in polymer compositions in order to achieve a desired conductivity may not have the expected or desired impact.

A need exists for polymer compositions that exhibit both thermal conductivity and resistance to thermal degradation, desirably without compromising the mechanical performance of the polymer composition.

### SUMMARY

A polymer composition is provided, comprising:
from 25 to 50 wt. % of a thermoplastic polymer;
from 10 to 45 wt. % of a thermally conductive filler;
from 15 to 30 wt. % of an electrically conductive carbon fiber;
from 2 to 8 wt. % of a toughener; and
less than 5 wt. % additives;
   wherein
wt. % is based on the total weight of the polymer composition,
wherein the polymer composition is substantially free of glass fibers, and
the through-plane conductivity of the polymer composition is at least 1.5 W/(m·K).

Articles comprising the polymer composition are also provided, for example selected from the group consisting of a structural or functional part of i) an electronic device, ii) an automobile, iii) a motor, iv) a battery, v) an LED, vi) an electronic board, vii) an electronic vehicle charging station, viii) a vacuum or vacuum system, etc.

### DESCRIPTION OF THE DRAWINGS

FIG. 1 is a bar graph illustrating the in-plane thermal conductivity (W/m·K) of various comparative (C1-C3) and inventive (E1-E3) polymer compositions;

FIG. 2 is a bar graph illustrating tensile modulus (GPa) of various comparative (C1-C3) and inventive (E1-E3) polymer compositions;

FIG. 3 is a bar graph illustrating the flexural modulus (GPa) of various comparative (C1-C3) and inventive (E1-E3) polymer compositions;

FIG. 4 is a bar graph illustrating the percent change in tensile break strain exhibited by the formulation with toughener, relative to the formulation without toughener, of various comparative (C1-C3) and inventive (E1-E3) polymer compositions; and

FIG. 5 is a bar graph illustrating the percent change in flexural break strain exhibited by the formulation with toughener, relative to the formulation without toughener, of various comparative (C1-C3) and inventive (E1-E3) polymer compositions.

### DETAILED DESCRIPTION

There are provided polymer compositions comprising a thermoplastic polymer, at least one thermally conductive filler, a carbon fiber and a toughener. Significantly, the polymer compositions are substantially free of glass fibers. It has surprisingly been found that the polymer compositions described herein have significantly improved thermal conductivity relative to analogous polymer compositions without toughener and/or analogous polymer compositions in which the carbon fiber is replaced by glass fiber.

Further, the elongation/break strain of the polymer compositions comprising carbon fibers and toughener is increased, while the tensile and flexural moduli of the polymer compositions are substantially maintained relative to analogous polymer compositions without toughener.

As used herein, polymer compositions that are “substantially free” of an indicated component (e.g. glass fiber) have a concentration of the indicated component that is less than 5 wt. %, or 4 wt. %, or 3 wt. %, or 2 wt. % or 1 wt. %. As used herein, wt. % is relative to the total weight of the polymer composition, unless explicitly indicated otherwise.

As used herein, “substantially maintained” is meant to indicate that a property has changed no more than 30%, no more than 20%, no more than 15%, no more than 10%, no more than 5%, or no more than 1%, relative to the property measured in an analogous polymer composition without a toughener.

Any description, even though described in relation to a specific embodiment, is applicable to and interchangeable with other embodiments of the present disclosure. Further, any element or component recited in a list of elements or components may be omitted from such list.

Any recitation of numerical ranges by endpoints includes all numbers and subranges subsumed within the recited ranges as well as the endpoints of the range.

As used herein, the mol % of a particular recurring unit is determined relative to the total number of recurring units in the indicated polymer, unless explicitly indicated otherwise.

The amount of energy in the form of heat required to bring about a change of state of a thermoplastic polymer from the solid to the liquid form is the heat of fusion (“ΔH_{f}”), and the temperature at which this change of state occurs is called the melting temperature (Tm). ΔH_{f} and Tm can be measured according to ASTM D3418.

The glass transition temperature (Tg) is the temperature at which an amorphous material (or an amorphous region within a semicrystalline material) transitions from a hard and relatively brittle state into a viscous or rubbery state. Tg can be measured according to ASTM E1356, “Standard Test Method for Assignment of the Glass Transition Temperatures by Differential Scanning Calorimetry.”

The terms “halogen” or “halo” include fluorine, chlorine, bromine and iodine.

Unless specifically limited otherwise, the term “alkyl”, as well as derivative terms such as “alkoxy”, “acyl” and “alkylthio”, as used herein include within their scope straight chain, branched chain and cyclic moieties. Examples of alkyl groups are methyl, ethyl, 1-methylethyl, propyl, 1,1-dimethylethyl and cyclopropyl.

Similarly, unless specifically stated otherwise, the term “aryl” refers to a phenyl, indanyl or naphthyl group. The aryl group may comprise one or more alkyl groups, and if this is the case, may be referred to as “alkylaryl.” An aromatic group, for example, may be substituted with one or more C1-C6 alkyl groups, such as methyl or ethyl.

An aryl group may also comprise one or more heteroatoms, e.g., N, O, or S, and in such instances may appropriately be referred to as a “heteroaryl” group. Such heteroaromatic rings may also be fused to other aromatic systems. Examples of heteroaromatic rings include, but are not limited to, furanyl, thienyl, pyrrolyl, pyrazolyl, imidazolyl, triazolyl, isoxazolyl, oxazolyl, thiazolyl, isothazolyl, pyridyl, pyridazyl, pryimidyl, pyrazinyl and triazinyl ring structures.

Unless specifically stated otherwise, each alkyl, aryl and heteroaryl group may be unsubstituted or substituted with one or more substituents selected from but not limited to halogen, hydroxy, sulfo, C1-C6 alkoxy, C1-C6 alkylthio, C1-C6 acyl, formyl, cyano, C6-C15 aryloxy or C6-C15 aryl, provided that the substituents are sterically compatible and the rules of chemical bonding and strain energy are satisfied.

### The Thermoplastic Polymer

The polymer composition comprises a thermoplastic polymer. Generally, any thermoplastic polymer may find benefit from application of the principles described herein, but those contemplated for use in applications wherein high heat conductivity and electrical resistivity are desired are of particular interest. Suitable thermoplastic polymers for use in the polymer composition include, but are not limited to, a poly(arylene sulfide), a polyamide, a poly(aryl ether sulfone), a poly(aryl ether ketone), a liquid crystal polymer, and/or a polyester.

In some embodiments, the polymer composition comprises at least 15 wt. %, at least 20 wt. %, or at least 25 wt. % of the thermoplastic polymer. In some embodiments, the polymer composition comprises no more than 60 wt. %, no more than 55 wt. %, or no more than 50 wt. % of the thermoplastic polymer. In some embodiments, the polymer composition comprises from 15 wt. % to 60 wt. %, from 20 wt. % to 55 wt. %, or from 25 wt. % to 50 wt. % of the thermoplastic polymer.

In some embodiments, the polymer composition can include a plurality of thermoplastic polymers, including but not limited to those recited above. In such embodiments, the total concentration of thermoplastic polymers is within the ranges given above.

In some embodiments, the thermoplastic polymer is semi-crystalline. As used herein, a semi-crystalline polymer has a heat of fusion (“ΔH_{f}”) is at least 5 J/g. As such, in some embodiments, the thermoplastic polymer has a ΔH_{f} (at a heating rate of 20° C./min) of at least 5 J/g, at least 10 J/g, at least 20 J/g, or at least 25 J/g. In some embodiments, the thermoplastic polymer has a ΔH_{f} of no more than 90 J/g, no more than 80 J/g, no more than 70 J/g or no more than 60 J/g. In some embodiments, the thermoplastic polymer has a ΔH_{f} of from 5 J/g to 90 J/g, from 10 J/g to 80 J/g, from 20 J/g to 70 J/g or from 25 J/g to 60 J/g.

### Poly(Arylene Sulfide)

In some embodiments, the thermoplastic polymer is a poly(arylene sulfide) (PAS). As used herein, a poly(arylene sulfide) refers to any polymer including at least 50 mol % of a recurring unit (R_{PAS}) of formula (I):

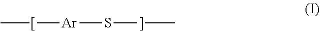

wherein Ar is an arylene.

In some embodiments, recurring unit (R_{PAS}) is represented by a formula selected from the following group of formulae:

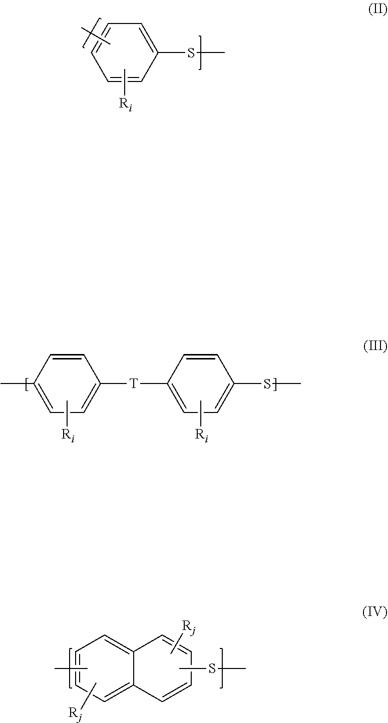

wherein
R, at each instance, is independently selected from the group consisting of a halogen, a C₁-C₁₂alkyl group, a C₇-C₂₄ alkylaryl group, a C₇-C₂₄ aralkyl group, a C₆-C₂₄ arylene group, a C₁-C₁₂ alkoxy group and a C₀₆-C₁₈ aryloxy group;
T is selected from the group consisting of a bond, —CO—, —SO₂—, —O—, —C(CH₃)₂, —C(CF₃)₂—, phenyl and —CH₂—;
i, at each instance, is independently an integer from 0 to 4; and
j, at each instance, is independently an integer from 0 to 3.

In recurring units (R_{PAS}), respective phenylene moieties may independently have 1,2-, 1,3- or 1,4-linkages to moieties other than R. In some embodiments, the phenylene moieties each independently have 1,3 or 1,4-linkages to moieties other than R. Preferably, the phenylene moieties have 1,4-linkages to moieties other than R.

In one embodiment, —Ar— of formula (I) is a phenyl group, so that the recurring unit (R_{PAS}) is represented by formula (II). Preferably, —Ar— of formula (I) is represented by Formula (II) wherein i is 0 and the phenylene moieties have 1,4-linkages to moieties other than R so that recurring unit (R_{PAS}) is represented by the following formula (II′):

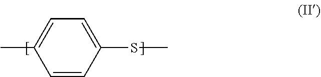

In such embodiments, the poly(arylene sulfide) is a polyphenylene sulfide.

In some embodiments, the concentration of recurring unit (R_{PAS}) of formulae (II), (II′), (Ill) and/or (IV) in the poly(arylene sulfide) is at least 60 mol %, at least 70 mol %, at least 80 mol %, at least 90 mol %, at least 95 mol %, at least 98 mol %, at least 99 mol % or at least 99.9 mol %. In such embodiments, the poly(arylene sulfide) consists essentially of recurring unit (R_{PAS}). In other embodiments, the concentration of recurring unit (R_{PAS}) of formulae (II), (II′), (III) and/or (IV) in the poly(arylene sulfide) is 100 mol % and in these embodiments, the poly(arylene sulfide) consists of recurring unit (R_{PAS}).

In some embodiments, the poly(arylene sulfide) has a weight average molecular weight (“M_{w}”) of at least 10,000 g/mol, at least 20,000 g/mol, at least 25,000 g/mol, at least 30,000 g/mol, or at least 35,000 g/mol. In some embodiments, the poly(arylene sulfide) has an M_{w} of no more than 150,000 g/mol, no more than 100,000 g/mol, no more than 90,000 g/mol, no more than 85,000 g/mol, or no more than 80,000 g/mol. In some embodiments, the poly(arylene sulfide) has an M_{w} of from 10,000 g/mol to 150,000 g/mol, from 20,000 g/mol to 100,000 g/mol, from 25,000 g/mol to 90,000 g/mol, from 30,000 g/mol to 85,000 g/mol, or from 35,000 g/mol to 80,000 g/mol. The M_{w} of poly(arylene sulfide) can be measured with gel permeation chromatography (“GPC”) using a 4-chloronapthalene standard.

In some embodiments, the poly(arylene sulfide) has a melting temperature (“Tₘ”) of at least 200° C., at least 220° C., at least 240° C., or at least 250° C. In some embodiments, the poly(arylene sulfide) (PAS) has a Tₘ of no more 350° C., no more than 320° C., no more than 300° C., or no more than 285° C. In some embodiments, the poly(arylene sulfide) (PAS) has a Tₘ of from 200° C. to 350° C., from 220° C. to 320° C., from 240° C. to 300° C., or from 250° C. to 285° C.

The melt flow rate (at 316° C. under a weight of 5 kg according to ASTM D1238, procedure B) of poly(phenylene sulfide) (a poly(arylene sulfide) according to formula (II′)) may be from 50 to 400 g/10 min, for example from 60 to 300 g/10 min or from 70 to 200 g/10 min.

Poly(arylene sulfide) and poly(phenylene sulfide) can be prepared by known methods.

### Polyamide

In some embodiments, the thermoplastic polymer is a polyamide (PA). A polyamide refers to a polymer including at least 50 mol % of recurring units having at least one amide bond (—CONH—). In some embodiments, the polyamide includes recurring units (R_{PA}) of formula (V):

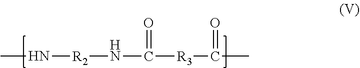

### Wherein

R₂ is selected from the group consisting of a bond, a C₁-C₁₅ alkyl and a C₆-C₃₀ aryl;
R₃ is selected from the group consisting of a C₁-C₂₀ alkyl, a phenyl, an indanyl, and a napthyl; and
R₂ and R₃ may each independently optionally comprise one or more heteroatoms (e.g. O, N or S) and optionally substituted with one or more substituents selected from the group consisting of halogen, hydroxy (—OH), sulfo (—SO₃H), C₁-C₆ alkoxy, C₁-C₆ alkylthio, C₁-C₆ acyl, formyl, cyano, C₆-C₁₅ aryloxy and C₆-C₁₅ aryl.

In some embodiments, R₃ in formula (V) is a phenyl and the polyamide is a polyphthalamide in accordance with formula (VI):

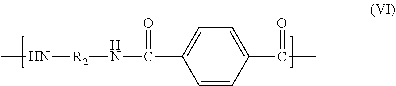

In some embodiments, the polyamide includes at least 60 mol %, at least 70 mol %, at least 80 mol %, at least 90 mol %, at least 95 mol %, at least 98 mol %, at least 99 mol % or at least 99.9 mol % percent of recurring units (R_{PA}) according to formulae (V) and/or (VI). In such embodiments, the poly(arylene sulfide) consists essentially of recurring unit (R_{PA}) of formula (V) and/or (VI). In other embodiments, the polyamide is such that 100 mol. % of the recurring units are recurring units (R_{PA}) of formula (V) and/or (VI). According to such embodiments, the polyamide consists of recurring units (R_{PA}) of formula (V) and/or (VI).

In some embodiments, the polyamide has an M_{w} of at least 15,000 g/mol, at least 20,000 g/mol, at least 25,000 g/mol, at least 30,000 g/mol, or at least 35,000 g/mol. In some embodiments, the polyamide has an M_{w} of no more than 150,000 g/mol, no more than 100,000 g/mol, no more than 90,000 g/mol, no more than 85,000 g/mol, or no more than 80,000 g/mol. In some embodiments, the polyamide has an M_{w} of from 15,000 g/mol to 150,000 g/mol, from 20,000 g/mol to 100,000 g/mol, from 25,000 g/mol to 90,000 g/mol, from 30,000 g/mol to 85,000 g/mol, or from 35,000 g/mol to 80,000 g/mol. The M_{w} of polyamide can be measured with gel permeation chromatography (“GPC”) using polymethylmethacrylate standards.

In some embodiments, the polyamide has a Tm of at least 200° C., at least 220° C., at least 240° C., or at least 250° C. In some embodiments, the polyamide has a Tm of no more 370° C., no more than 360° C., no more than 350° C. or no more than 340° C. In some embodiments, the polyamide has a Tm of from 200° C. to 370° C., from 220° C. to 360° C., from 240° C. to 350° C., or from 250° C. to 340° C.

Polyamides and polyphthalamides can be prepared by known methods.

### Poly(Aryl Ether Sulfone)

In some embodiments, the thermoplastic polymer is a poly(aryl ether sulfone) (PAES). Poly(aryl ether sulfone)s include, but are not limited to, polysulfone, polyphenylsulfone and polyether sulfone.

A poly(aryl ether sulfone) refers to any polymer including at least 50 mol. % of a recurring units (R_{PAES}) of formula (VII):

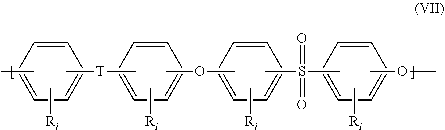

wherein
R, at each instance, is independently selected from the group consisting of a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
i, for each R, is independently an integer from 0 to 4, and T is selected from the group consisting of a bond, a sulfone group [—S(═O)₂₋], and a group of formula (VIII)

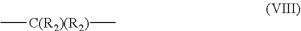

wherein
R₂, at each instance, is independently selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium.

T is preferably a bond (i.e., the polyarylether sulfone is a polyphenylsulfone), a sulfone group (i.e., the polyarylether sulfone is a polyethersulfone) or a group according to formula (VIII) in which each R₂ is a methyl group (i.e., the polyarylether sulfone is a polysulfone).

In recurring units (R_{PAES}), respective phenylene moieties may independently have 1,2-, 1,3- or 1,4-linkages to moieties other than R. In some embodiments, the phenylene moieties each independently have 1,3 or 1,4-linkages to moieties other than R. Preferably, the phenylene moieties have 1,4-linkages to moieties other than R.

In some embodiments, at least 60 mol %, at least 70 mol %, at least 80 mol %, at least 90 mol %, at least 95 mol %, at least 98 mol %, at least 99 mol % or at least 99.9 mol % of the recurring units in the poly(aryl ether sulfone) are recurring units (R_{PAES}). In such embodiments, the poly(aryl ether sulfone) consists essentially of recurring units (R_{PAES}). In other embodiments, the poly(aryl ether sulfone) is such that 100 mol. % of the recurring units are recurring units (R_{PAES}). According to such embodiments, the poly(aryl ether sulfone) consists of recurring units (R_{PAES}).

The poly(aryl ether sulfone) may have an M_{w} of from 30,000 g/mol to 80,000 g/mol, for example from 35,000 g/mol to 75,000 g/mol or from 40,000 g/mol to 70,000 g/mol. The M_{w} of poly(aryl ether sulfone) can be determined by gel permeation chromatography (GPC) using methylene chloride as a mobile phase (2×5μ mixed D columns with guard column from Agilent Technologies; flow rate: 1.5 mL/min; injection volume: 20 μL of a 0.2 w/v % sample solution), with polystyrene standards.

In some embodiments, the poly(aryl ether sulfone) has a Tg of at least 150° C., at least 160° C., at least 170° C., or at least 180° C. In some embodiments, the poly(aryl ether sulfone) has a Tg of no more 270° C., no more than 260° C., no more than 250° C., or no more than 240° C. In some embodiments, the poly(aryl ether sulfone) has a Tg of from 150° C. to 270° C., from 160° C. to 260° C., from 170° C. to 250° C., or from 170° C. to 240° C.

Poly(aryl ether sulfone) can be prepared by known methods.

### Polysulfone

In some embodiments, the thermoplastic polymer is a poly(aryl ether sulfone) and the poly(aryl ether sulfone) is a polysulfone (PSU). As used herein, a polysulfone refers to any polymer including at least 50 mol % of a recurring unit (R_{PSU}) of formula (VII-A):

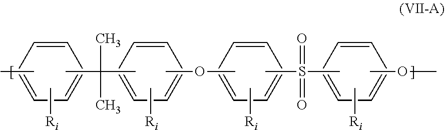

### Wherein

R, at each instance, is independently selected from the group consisting of a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
i, for each R, is independently an integer from 0 to 4.

In one embodiment, i is 0 for each R in formula (VII-A). According to this embodiment, the recurring units (R_{PSU}) are units of formula (VII-B):

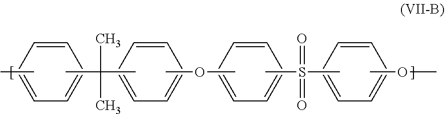

In recurring units (R_{PSU}), respective phenylene moieties may independently have 1,2-, 1,3- or 1,4-linkages to moieties other than R. In some embodiments, the phenylene moieties each independently have 1,3 or 1,4-linkages to moieties other than R. Preferably, the phenylene moieties have 1,4-linkages to moieties other than R.

In some embodiments, at least 60 mol %, at least 70 mol %, at least 80 mol %, at least 90 mol %, at least 95 mol %, at least 98 mol %, at least 99 mol % or at least 99.9 mol % of the recurring units in the polysulfone are recurring units (R_{PSU}) of formula (VII-A) and/or formula (VII-B). In such embodiments, the polysulfone consists essentially of recurring units (Rₚsu) of formula (VII-A) and/or formula (VII-B). In other embodiments, the polysulfone is such that 100 mol. % of the recurring units are recurring units (R_{PSU}) of formula (VII-A) and/or formula (VII-B). According to such embodiments, the polysulfone consists of recurring units (R_{PSU}) of formula (VII-A) and/or formula (VII-B).

In some embodiments, the M_{w} of the polysulfone is from 30,000 to 80,000 g/mol, for example from 35,000 to 75,000 g/mol or from 40,000 to 70,000 g/mol. The M_{w} of polysulfone can be determined by gel permeation chromatography (GPC) using methylene chloride as a mobile phase (2×5 μ mixed D columns with guard column from Agilent Technologies; flow rate: 1.5 mL/min; injection volume: 20 μL of a 0.2 w/v % sample solution), with polystyrene standards.

In some embodiments, the polysulfone has a Tg of at least 150° C., at least 160° C., at least 170° C., or at least 180° C. In some embodiments, the polysulfone has a Tg of no more 270° C., no more than 260° C., no more than 250° C., or no more than 240° C. In some embodiments, the polysulfone has a Tg of from 150° C. to 270° C., from 160° C. to 260° C., from 170° C. to 250° C., or from 170° C. to 240° C.

Polysulfone can be prepared by methods well known in the art.

### Polyphenylsulfone

In some embodiments, the thermoplastic polymer is a poly(aryl ether sulfone) and the poly(aryl ether sulfone) is a polyphenylsulfone (PPSU). As used herein, a polyphenylsulfone refers to any polymer including at least 50 mol % of a recurring unit (R_{PPSU}) of formula (VII-C):

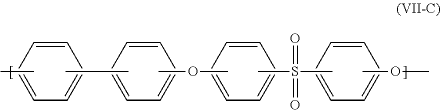

In some embodiments, at least 60 mol %, at least 70 mol %, at least 80 mol %, at least 90 mol %, at least 95 mol %, at least 98 mol %, at least 99 mol % or at least 99.9 mol % of all of the recurring units in the polyphenylsulfone are recurring units (R_{PPSU}). In such embodiments, the polyphenylsulfone consists essentially of recurring units (Rₚₚsu). In other embodiments, the polyphenylsulfone is such that 100 mol. % of the recurring units are recurring units (R_{PPSU}). According to such embodiments, the polyphenylsulfone consists of recurring units (R_{PPSU}).

In some embodiments, the polyphenylsulfone has an M_{w} of at least 20,000 g/mol, at least 30,000 g/mol, or at least 40,000 g/mol. In some embodiments, the polyphenylsulfone has an M_{w} of no more than 100,000 g/mol, no more than 90,000 g/mol, or no more than 80,000 g/mol. In some embodiments, the polyphenylsulfone has an M_{w} of from 20,000 g/mol to 100,000 g/mol, from 30,000 g/mol to 90,000 g/mol, or from 40,000 g/mol to 80,000 g/mol. The M_{w} of polyphenylsulfone can be measured with gel permeation chromatography (“GPC”) using polystyrene standards.

In some embodiments, the polyphenylsulfone has a Tg of at least 150° C., at least 160° C., at least 170° C., or at least 180° C. In some embodiments, the polyphenylsulfone has a Tg of no more 270° C., no more than 260° C., no more than 250° C., or no more than 240° C. In some embodiments, the polyphenylsulfone has a Tg of from 150° C. to 270° C., from 160° C. to 260° C., from 170° C. to 250° C., or from 170° C. to 240° C.

Polyphenylsulfone can be prepared by known methods.

### Polyethersulfone

In some embodiments, the thermoplastic polymer is a poly(aryl ether sulfone) and the poly(aryl ether sulfone) is a polyethersulfone (PES). As used herein, a polyethersulfone refers to any polymer including at least 50 mol % of a recurring unit (R_{PES}) of formula (VII-D):

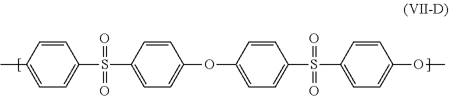

In some embodiments, at least 60 mol %, at least 70 mol %, at least 80 mol %, at least 90 mol %, at least 95 mol %, at least 98 mol %, at least 99 mol % or 99.9 mol % of the recurring units in the polyethersulfone are recurring units (R_{PES}). In such embodiments, the polyethersulfone consists essentially of recurring units (R_{PES}).

In other embodiments, the polyethersulfone is such that 100 mol. % of the recurring units are recurring units (R_{PES}). According to such embodiments, the polyethersulfone consists of recurring units (R_{PES}).

In some embodiments, the polyethersulfone has an M_{w} of at least 20,000 g/mol, at least 30,000 g/mol, or at least 40,000 g/mol. In some embodiments, the polyethersulfone has an M_{w} of no more than 100,000 g/mol, no more than 90,000 g/mol, or no more than 80,000 g/mol. In some embodiments, the polyethersulfone has an M_{w} of from 20,000 g/mol to 100,000 g/mol, from 30,000 g/mol to 90,000 g/mol, or from 40,000 g/mol to 80,000 g/mol. The M_{w} of polyethersulfone can be measured with gel permeation chromatography (“GPC”) using polystyrene standards.

In some embodiments, the polyethersulfone has a Tg of at least 150° C., at least 160° C., at least 170° C., or at least 180° C. In some embodiments, the polyethersulfone has a Tg of no more 270° C., no more than 260° C., no more than 250° C., or no more than 240° C. In some embodiments, the polyethersulfone has a Tg of from 150° C. to 270° C., from 160° C. to 260° C., from 170° C. to 250° C., or from 170° C. to 240° C.

Polyethersulfone can be prepared by known methods.

### Poly(Aryl Ether Ketone) (PAEK)

In some embodiments, the thermoplastic polymer is a poly(aryl ether ketone) (PAEK).

A poly(aryl ether ketone) refers to any polymer including at least 50 mol % of recurring units (R_{PAEK}) comprising a Ar′—C(═O)—Ar*group, where Ar′ and Ar*are the same, or different, aromatic groups.

As used herein, recurring units (R_{PAEK}) are recurring units of formulae (VIII)—(XI):

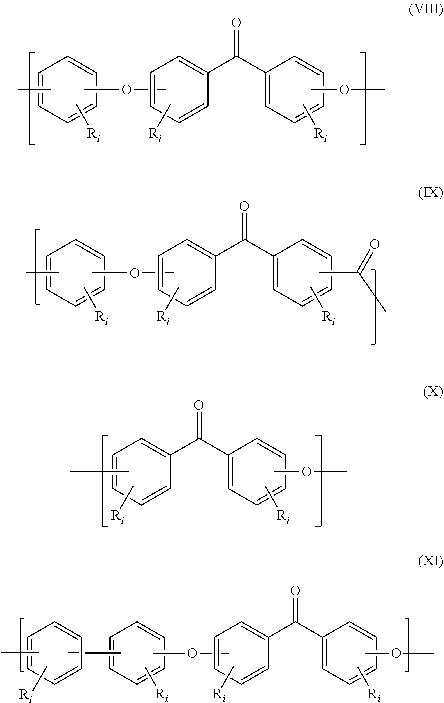

wherein
each R, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium with the understanding that each group capable of substitution may be substituted or unsubstituted, and if substituted, may comprise one or more heteroatoms, sulfonic acid and sulfonate groups, phosphonic and phosphonate groups, and amine and quaternary ammonium groups; and
i is independently an integer from 0 to 4.

In recurring unit (R_{PAEK}), the respective phenylene moieties may independently have 1,2-, 1,3- or 1,4-linkages to the other moieties different from R in the recurring unit (R_{PAEK}). In some embodiments, the phenylene moieties each independently have 1,3 or 1,4-linkages to moieties other than R. Preferably, the phenylene moieties have 1,4-linkages to moieties other than R.

In some embodiments of recurring units (R_{PAEK}), i is 0 for each R in formulae (VIII)-(XI). According to this embodiment, the recurring units (R_{PAEK}) are represented by formulae (VIII-A) to (XI-A):

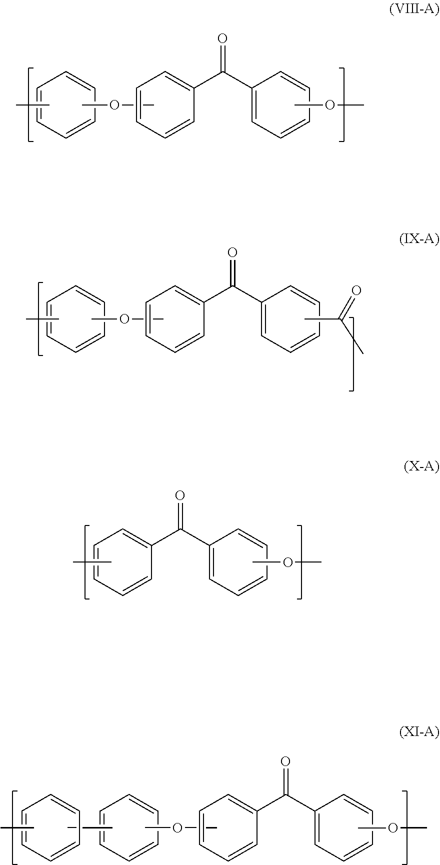

A polymer of which at least 50% of the recurring units are recurring units (R_{PAEK}) of formulae (VIII), (XI), (VIII-A) and/or (XI-A) are also understood by those of ordinary skill in the art to belong to the genus of poly(ether ether ketones) (PEEK).

According to an embodiment, at least 60 mol %, at least 70 mol %, at least 80 mol %, at least 90 mol %, at least 95 mol %, at least 98 mol %, at least 99 mol %, or at least 99.9 mol % of the recurring units in the poly(aryl ether ketone) are recurring units (R_{PAEK}) of formula (VIII), formula (IX), formula (X) and/or formula (XI). In such embodiments, the poly(aryl ether ketone) consists essentially of recurring units (R_{PAEK}) of formula (VIII), formula (IX), formula (X) and/or formula (XI).

In other embodiments, the poly(aryl ether ketone) is such that 100 mol. % of the recurring units are recurring units (R_{PAEK}) of formula (VIII), formula (IX), formula (X) and/or formula (XI). According to such embodiments, the poly(aryl ether ketone) consists of recurring units (R_{PAEK}) of formula (VIII), formula (IX), formula (X) and/or formula (XI).

In some embodiments, the poly(aryl ether ketone) has an M_{w} of at least 30,000 g/mol, at least 40,000 g/mol, or at least 50,000 g/mol. In some embodiments, the poly(aryl ether ketone) has an M_{w} of no more than 200,000 g/mol, no more than 175,000 g/mol, or no more than 150,000 g/mol. In some embodiments, the poly(aryl ether ketone) has an M_{w} of from 30,000 g/mol to 200,000 g/mol, from 40,000 g/mol to 175,000 g/mol, of from 50,000 g/mol to 150,000 g/mol. The M_{w} of poly(aryl ether ketone) can be measured with gel permeation chromatography (“GPC”) using polymethylmethacrylate standards.

In some embodiments, the poly(aryl ether ketone) has a Tm of at least 270° C., at least 280° C., at least 290° C., or at least 300° C. In some embodiments, the poly(aryl ether ketone) has a Tm of no more 400° C., no more than 390° C., no more than 380° C., or no more than 370° C. In some embodiments, the poly(aryl ether ketone) has a Tm of from 270° C. to 400° C., from 280° C. to 390° C., from 290° C. to 380° C., or from 280° C. to 370° C.

Poly(aryl ether ketone) and poly(ether ether ketone) can be prepared by known methods.

### Liquid Crystal Polymer

In some embodiments, the thermoplastic polymer is a liquid crystal polymer. Liquid crystal polymers are formed from the polycondensation of the following monomers: terephthalic acid, an aromatic diol, a first aromatic dicarboxylic acid distinct from terephthalic acid, and an aromatic hydroxycarboxylic acid.

In some embodiments, the aromatic diol is represented by a formula selected from formulae (XII) and (XIII):

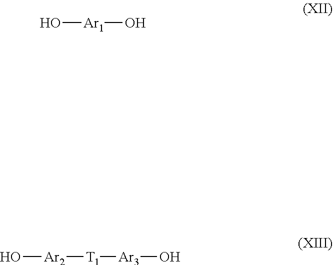

### Wherein

Ar₁ to Ar₃ are independently selected C₆-C₃₀ aryl groups, optionally substituted with one or more substituents selected from the group consisting of halogen, a C₁-C₁₅ alkyl, and a C₆-C₁₅ aryl; and
T₁ is selected from the group consisting of a bond, O, S, —SO₂—, —C(═O)—, and a C₁-C₁₅ akyl.

In some embodiments, the aromatic diol is selected from the group consisting of 1,3-dihydroxybenzene, 1,4-dihydroxybenzene, 2,5-biphenyldiol, 4,4′-biphenol, 4,4′-(propane-2,2-diyl)diphenol, 4,4′-(ethane-1,2-diyl)diphenol, 4,4′-methylenediphenol, bis(4-hydroxyphenyl)methanone, 4,4′-oxydiphenol, 4,4′-sulfonyldiphenol, 4,4′-thiodiphenol, naphthalene-2,6-diol, and naphthalene-1,5-diol. Preferably, the aromatic diol is 4,4′-biphenol.

In some embodiments, the first aromatic dicarboxylic acid is independently represented by a formula selected from formulae (XIV) and (XV):

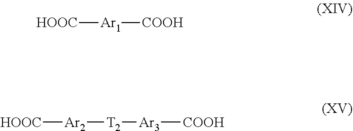

where Ar₁ to Ar₃ are as defined above and are independently selected; and T₂ is selected from the group consisting of a bond, O and S.

In some embodiments, the first aromatic dicarboxylic acid is selected from the group consisting of isophthalic acid, 4,4′-biphenyldicarboxylic acid, 4,4′-oxydibenzoic acid, 4,4′-(ethylenedioxy)dibenzoic acid, 4,4′-sulfanediyldibenzoic acid, naphthalene-2,6-dicarboxylic acid, naphthalene-1,4-dicarboxylic acid, naphthalene-1,5-dicarboxylic acid, and naphthalene-2,3-dicarboxylic acid. Preferably the first aromatic dicarboxylic acid is selected from the group consisting of isophthalic acid, naphthalene-2,6-dicarboxylic acid, naphthalene-1,4-dicarboxylic acid, naphthalene-1,5-dicarboxylic acid, and naphthalene-2,3-dicarboxylic acid. Most preferably, the first aromatic dicarboxylic acid is isophthalic acid.

In some embodiments, the aromatic hydroxycarboxylic acid is represented by a formulae selected from formulae (XVI) and (XVII):

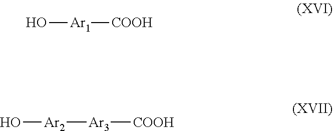

wherein Ar₁ to Ar₃ are as defined above and are independently selected.

In some embodiments, the aromatic hydroxycarboxylic acid is selected from the group consisting of 4-hydroxybenzoic acid, 3-hydroxybenzoic acid, 6-hydroxy-2-naphthoic acid, 6-hydroxy-1-naphthoic acid, 2-hydroxy-1-naphthoic acid, 3-hydroxy-2-naphthoic acid, 1-hydroxy-2-naphthoic acid, 5-hydroxy-1-naphthoic acid, and 4′-hydroxy-[1,1′-biphenyl]-4-carboxylic acid. Preferably, the aromatic hydroxycarboxylic acid is selected from the group consisting of 4-hydroxybenzoic acid, 6-hydroxy-2-naphthoic acid, 6-hydroxy-1-naphthoic acid, 2-hydroxy-1-naphthoic acid, 3-hydroxy-2-naphthoic acid, 1-hydroxy-2-naphthoic acid, and 5-hydroxy-1-naphthoic acid. Most preferably, the aromatic hydroxycarboxylic acid is 4-hydroxybenzoic acid.

As used herein, an LCP refers to any polymer formed from the aforementioned monomers and having at least 50% of recurring units (R_{LCP}) of formulae (XVIII)-(XI):

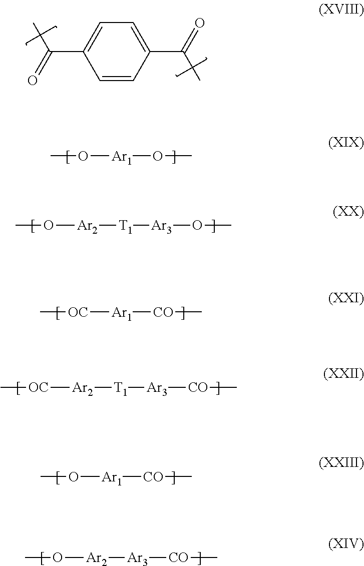

wherein Ar₁ to Ar₃, T₁ and T₂ are as defined above and are independently selected.

One of ordinary skill in the art will recognize that R_{LCP} according to formula (XVIII) is formed from terephthalic acid; R_{LCP} according to formulae (XIX) and (XX) are respectively formed from monomers according to formulae (XII) and (XIII); R_{LCP} according to formulae (XXI) and (XXII) are respectively formed from monomers according to formulae (XIV) and (XV); and R_{LCP} according to formulae (XXIII) and (XXIV) are formed from monomers according to formulae (XVI) and (XVII). As such, the selection of Ar to Ar₃, T₁ and T₂ for the monomers in formulae (XII) to (XVII) also selects Ar to Ar₃, T₁ and T₂ for recurring units R_{LCP} according to formulae (XIX) to (XIXV). Preferably, recurring units R_{LCP} according to formula (XVIII) are formed by the polycondensation of terephthalic acid, recurring units R_{LCP} according to formulae (XIX) and (XX) are formed by the polycondensation of 4,4′-biphenol, recurring units R_{LCP} according to formulae (XXI) and (XXII) are formed by the polycondensation of isophthalic acid and recurring units R_{LCP} according to formulae (XXIII) and (XXIV) are formed by the polycondensation of 4-hydroxybenzoic acid.

In some embodiments, the total concentration of recurring units R_{LCP} according to formulae (XVIII) to (XXIV) is at least 50 mol %, at least 60 mol %, at least 70 mol %, at least 80 mol %, at least 90 mol %, at least 95 mol %, at least 99 mol %, or at least 99.9 mol %.

In some embodiments, the concentration of recurring units R_{LCP} according to formula (XVIII) is from 5 mol % to 30 mol %, preferably from 10 mol % to 20 mol %. In some embodiments, the concentration of recurring units R_{LCP} according to formulae (XIX) and/or (XX) is from 10 mol % to 30 mol %, preferably from 15 mol % to 25 mol %. In some embodiments, the concentration of recurring units R_{LCP} according to formulae (XXI) and (XXII) is from 1 mol % to 20 mol %, preferably from 1 mol % to 10 mol %. In some embodiments, the concentration of recurring units R_{LCP} according to formulae (XXIII) and (XXIV) is from 35 mol % to 80 mol %, preferably from 45 mol % to 75 mol %, most preferably from 50 mol % to 70 mol %.

In some embodiments, the LCP has an M_{w} of at least 20,000 g/mol. In some embodiments, the LCP has an M_{w} of no more than 80,000 g/mol. In some embodiments, the LCP has an M_{w} of from 20,000 g/mol to 80,000 g/mol. The Mw can be determined by gel permeation chromatography (GPC) according to ASTM D5296 and using hexafluoroisopropanol solvent and poly(methyl methacrylate) standard.

In some embodiments, the LCP has a Tm of at least 220° C., at least 250° C., or at least 280° C. In some embodiments, the LCP has a Tm of no more than 420° C., no more than 390° C., or no more than 360° C. In some embodiments, the LCP has a Tm of from 220° C. to 420° C., from 250° C. to 390° C., or from 280° C. to 360° C.

Liquid crystal polymers can be prepared by known methods.

### Polyester

In some embodiments, the thermoplastic polymer is a polyester. As used herein, a polyester refers to any polymer including at least 50 mol % of recurring units (R_{PE}) which contains an ester group (—C(═O)—O—). In some embodiments, the polyester includes recurring units (R_{PE}) of formula (XXV):

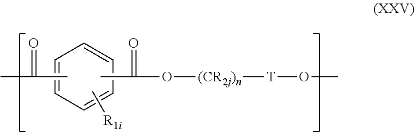

### Wherein

R1 and R2 are each independently selected from the group consisting of a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium;
T is a bond, or a substituted cycloaliphatic group containing a monovalent alkyl group and monovalent cycloaliphatic group;
i is an integer from 0 to 4;
j is an integer from 0 to 2; and
n is an integer from 1 to 12.

In recurring units (R_{PE}), respective phenylene moieties may independently have 1,2-, 1,3- or 1,4-linkages to moieties other than R. In some embodiments, the phenylene moieties each independently have 1,3 or 1,4-linkages to moieties other than R. Preferably, the phenylene moieties have 1,4-linkages to moieties other than R.

In some embodiments, i and j are each zero, T is a bond, and/or n is 2 or 4. In some such embodiments, the polyester polymer is polytrimethylene terephthalate (i and j are 0, T is a bond and n is 1); polyethylene terephthalate (i and j are 0, T is a bond and n is 2); or polybutylene terephthalate (i and j are 0, T is a bond and n is 4).

In some embodiments, at least 60 mol %, at least 70 mol %, at least 80 mol %, at least 90 mol %, at least 95 mol %, at least 98 mol %, at least 99 mol % or at least 99.9 mol % of the recurring units in the polyester are recurring units (R_{PE}). In such embodiments, the polyester consists essentially of recurring units (R_{PE}). In other embodiments, the polyester is such that 100 mol. % of the recurring units are recurring units (R_{PE}). According to such embodiments, the polyester consists of recurring units (R_{PE}).

In some embodiments, the polyester has an M_{w} of at least 10,000 g/mol, at least 20,000 g/mol, or at least 30,000 g/mol. In some embodiments, the polyester has an M_{w} of no more than 100,000 g/mol, no more than 90,000 g/mol, or no more than 80,000 g/mol. In some embodiments, the polyester has an M_{w} of from 10,000 g/mol to 100,000 g/mol, from 20,000 g/mol to 90,000 g/mol, of from 30,000 g/mol to 80,000 g/mol. The M_{w} of polyester can be measured with gel permeation chromatography (“GPC”) using polymethylmethacrylate standards.

In some embodiments, the polyester has a Tm of at least 250° C., preferably at least 260° C., more preferably at least 270° C. and most preferably at least 280° C. In some embodiments, the polyester polymer has a melting point of at most 350° C., preferably at most 340° C., more preferably at most 330° C. and most preferably at most 320° C. In some embodiments, the polyester has a Tm of from 250° C. to 350° C., from 260° C. to 340° C., from 270° C. to 330° C., or from 280° C. to 320° C.

Polyesters can be prepared by known methods.

### The Thermally Conductive Fillers

The polymer composition comprises a thermally conductive filler. As used herein, a thermally conductive filler has a thermal conductivity of at least 0.5 W/(m·K), at least 2 W/(m·K), or at least 4 W/(m·K), as measured by ASTM E1461-13. Useful thermally conductive fillers include, but are not limited to, inorganic oxides and nitrides including, but not limited to, aluminum oxide (alumina), zinc oxide, magnesium oxide and silicon dioxide, boron nitride, aluminum nitride and silicon nitride; metal and metal alloys; silicon carbide powder; zinc sulfide, magnesium carbonate and calcium fluoride powder; and the like.

Preferably, thermally conducting fillers are selected from the group consisting of inorganic oxides or nitrides, and more preferably, thermally conducting fillers are selected from magnesium oxide, zinc oxide, boron nitride and combinations of these. In some embodiments, boron nitride is particularly preferred.

In some embodiments, the polymer composition comprises at least 5 wt. %, at least 10 wt. %, or at least 15 wt. % of the thermally conductive filler. In some embodiments, the polymer composition comprises no more than 50 wt. %, no more than 45 wt. % or no more than 40 wt. % of the thermally conductive filler. In some embodiments, the polymer composition comprises from 5 wt. % to 50 wt. %, from 10 wt. % to 45 wt. %, or from 15 wt. % to 40 wt. % of the thermally conductive filler.

### The Carbon Fiber

The polymer composition comprises a carbon fiber. In some embodiments, the polymer composition comprises at least 5 wt. %, or at least 10 wt. %, or at least 15 wt. % of the carbon fiber. In some embodiments, the polymer composition comprises no more than 40 wt. %, or no more than 35 wt. %, or no more than 30 wt. % of the carbon fiber. In some embodiments, the polymer composition comprises from 5 wt. % to 40 wt. %, or from 10 wt. % to 35 wt. %, or from 15 wt. % to 30 wt. % of the carbon fiber.

The carbon fiber is generally cylindrical and is characterized by a length (“L”, along the long axis of the carbon fiber) and a cross-sectional diameter (“D”, referred to simply as diameter) that is perpendicular to the length of the carbon fiber.

In some embodiments, the carbon fiber has an average length of at least 5 μm, at least 50 μm, at least 100 μm, at least 150 μm or at least 175 μm. In some embodiments, the carbon fiber has an average length of no more than 400 μm, no more than 350 μm, no more than 300 μm, no more 250 μm or no more than 225 μm. In some embodiments, the carbon fiber has an average length of from 5 μm to 400 μm, from 50 μm to 350 μm, from 100 μm to 300 μm, from 150 μm to 250 μm or from 175 μm to 225 μm.

In some embodiments, the carbon fiber has an average diameter of at least 1 μm, at least 5 μm, at least 7 μm or at least 8 μm. In some embodiments, the carbon fiber has an average diameter of no more than 20 μm, no more than 15 μm, no more than 13 μm or no more than 12 μm. In some embodiments, the carbon fiber has an average diameter of from 1 μm to 20 μm, from 5 μm to 15 μm, from 7 μm to 13 μm or from 8 μm to 12 μm.

In some embodiments, the length of the carbon fiber is significantly larger than its diameter. In some embodiments, the carbon fiber has an aspect ratio, defined as the average ratio of the length and the largest diameter (L/D) of at least 5, at least 10, at least 15, at least 20, or at least 25, or at least 30 or at least 50.

### The Toughener

The polymer composition comprises a toughener. Tougheners are amorphous polymers, generally having a low Tg, with a Tg for example below room temperature, below 0° C. or even below −25° C. As a result of its low Tg, a toughener is typically elastomeric at room temperature. Tougheners can be functionalized polymer backbones.

The polymer backbone of the toughener can be selected from elastomeric backbones comprising polyethylenes and copolymers thereof, e.g. ethylene-butene; ethylene-octene; polypropylenes and copolymers thereof;
polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride. In some embodiments, the toughener is a terpolymer of ethylene, acrylic ester and glycidyl methacrylate, a copolymers of ethylene and butyl ester acrylate; or a copolymer of ethylene, butyl ester acrylate and glycidyl methacrylate.

In some embodiments, the concentration of the toughener in the polymer composition is at least 0.1 wt. %, at least 0.5 wt. %, at least 1 wt. %, at least 1.5 wt. %, at least 2 wt. %, or at least 2.5 wt. %. In some embodiments, the toughener concentration in the polymer composition is no more than 10 wt. %, no more than 9.5 wt. %, no more than 9 wt. %, no more than 8.5 wt. %, or no more than 8 wt. %. In some embodiments, the toughener concentration is the polymer composition is from 0.1 wt. % to 10 wt. %, from 0.5 wt. % to 9.5 wt. %, from 1 wt. % to 9 wt. %, from 1.5 wt. % to 8.5 wt. %, or from 2 wt. to 8 wt. %.

### Additives

The polymer composition may also comprise one or more additives commonly used in the art including plasticizers, colorants, pigments, (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants, nucleating agents and antioxidants. As used herein, additives exclude the thermally conductive fillers, the carbon fibers and the toughener.

In embodiments including additives, the total additive concentration is less than 5 wt. %, or less than 4 wt. %, or less than 3 wt. %, or less than 2 wt. %, or less than 1 wt. %.

### The Polymer Composition

The present polymer composition comprises a thermoplastic polymer, a thermally conductive filler, a carbon fiber and a toughener. Also, as previously mentioned, the polymer composition is substantially free of glass fiber.

In some embodiments, the weight ratio of the total weight of the carbon fiber(s) and toughener to the total weight of all non-thermoplastic polymer components in the polymer composition is no more than 1:3.5, no more than 1:3.4, no more than 1:3.3, or no more than 1:3.2.

In some embodiments, the ratio of the total weight of the carbon fiber to the total weight of all non-thermoplastic polymer components in the polymer composition is at least 1:1, at least 1:1.1, at least 1:1.2, or at least 1:1.3.

In some embodiments, the ratio of the total weight of carbon fiber to the total weight of all non-thermoplastic polymer components in the polymer composition is from 1:1.0 to 1:3.5, from 1:1.1 to 1:3.4, from 1:1.2 to 1:3.3, or from 1:1.3 to 1:3.2.

As mentioned above, the combination of the carbon fiber and the toughener provides surprising enhancements to the through-plane thermal conductivity of the polymer composition as compared to analogous polymer compositions without toughener and/or in which the carbon fiber is replaced with glass fiber. This result is particularly surprising as tougheners are amorphous and understood by those of ordinary skill in the art to reduce thermal conductivity. In some embodiments, the polymer composition exhibits through-plane thermal conductivity of at least 1.5 W/(m·K), at least 1.75 W/(m·K), at least 2 W/(m·K), at least 2.25 W/(m·K), at least 2.5 W/(m·K), at least 2.75 W/(m·K), at least 3 W/(m·K), at least 3.25 W/(m·K), or at least 3.5 W/(m·K). In some embodiments, the polymer composition exhibits an increase in through-plane thermal conductivity of at least 20%, at least 25%, at least 30%, at least 35%, at least 40%, at least 45%, at least 50%, at least 55%, at least 60%, at least 65%, or at least 70% more than the thermal conductivity of an analogous polymer composition comprising carbon fibers but no toughener. Through-plane thermal conductivity can be measured by the flash method according to ASTM E1461-13, “Standard Test Method for Thermal Diffusivity by the Flash Method”.

The thermal conductivity improvements do not come at the expense of the elongation of the polymer composition, which is surprisingly and unexpectedly increased as compared to the analogous polymer composition comprising carbon fibers but not comprising the toughener. In some embodiments, the elongation, measured as either the tensile or flexural break strain, of the polymer composition is increased by at least 50%, at least 55%, at least 60%, at least 65%, at least 70%, at least 75%, at least 80%, at least 85%, at least 90%, at least 95%, or even 100% as compared to the analogous polymer composition comprising carbon fibers but not comprising the toughener. In some embodiments, the elongation of the polymer composition comprising the carbon fibers and toughener increases more than 100%, or more than doubles, relative to the elongation of the analogous polymer composition comprising carbon fibers, but not comprising the toughener.

Further surprising is the fact that the tensile and flexural moduli of the polymer compositions comprising carbon fibers and toughener are substantially maintained as compared to analogous polymer compositions comprising carbon fibers, but not comprising the toughener. In some embodiments, the tensile and flexural moduli of the polymer compositions are within 30%, within 20%, within 15%, within 10%, within 5%, or within 1%, of the property measured in an analogous polymer composition comprising carbon fibers but without a toughener.

In some embodiments, the polymer composition has only a single thermoplastic polymer and/or a single thermally conductive filler. In some such embodiments, the thermoplastic polymer is either polyphenyl sulfide or polyphthalamide, and/or the thermally conductive filler is boron nitride.

### Methods of Making the Polymer Compositions

Methods of making the polymer composition are also provided.

The polymer composition can be made by methods well known to the person of skill in the art. For example, such methods include, but are not limited to, melt-mixing processes. Melt-mixing processes are typically carried out by heating the polymer components above the glass transition or melting temperature of the thermoplastic polymers. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the barrel. The components may be fed simultaneously, i.e., as a dry blend of one or more powders granules, or may be fed separately.

The order of combination the components during melt-mixing is not particularly limited. In one embodiment, the component can be mixed in a single batch, such that the desired amounts of each component are added together and subsequently mixed. In other embodiments, a first sub-set of components can be initially mixed together and one or more of the remaining components can be added to the mixture for further mixing. For clarity, the total desired amount of each component does not have to be mixed as a single quantity. For example, for one or more of the components, a partial quantity can be initially added and mixed and, subsequently, some or all of the remainder can be added and mixed.

### Shaped Articles and Methods of Making

Filaments and shaped articles comprising the present polymer composition as well as methods of making the filaments and shaped articles are also provided.

The polymer composition are well suited for the manufacture of articles useful in a wide variety of applications. For example, the present polymer compositions may be especially suitable for use as a functional or structural part of i) an electronic device, ii) an automobile, iii) a motor, iv) a battery, v) an LED, vi) an electronic boards, vii) an electronic vehicle charging station, viii) a vacuum or vacuum system, etc.

Shaped articles may be made from the polymer composition using any suitable melt-processing method such as injection molding, extrusion molding, roto-molding, compression molding or blow-molding.

Shaped articles may also be made by additive manufacturing, where the shaped article is printed from the polymer composition.

Additive manufacturing systems are used to print or otherwise build a shaped object from a digital representation of the shaped object by one or more additive manufacturing techniques. Examples of commercially available additive manufacturing techniques include extrusion-based techniques, selective laser sintering, powder/binder jetting, electron-beam melting, and stereolithography processes. For each of these techniques, the digital representation of the shaped object is initially sliced into multiple horizontal layers. For each layer, a tool path is then generated, which provides instructions for the particular additive manufacturing system to print the given layer.

For example, in an extrusion-based additive manufacturing system, a shaped article may be printed from a digital representation of the shaped article in a layer-by-layer manner by extruding and adjoining strips of the polymer composition. The polymer composition is extruded through an extrusion tip carried by a print head of the system, and is deposited as a sequence of roads on a platen in an x-y plane. The extruded material fuses to previously deposited material and solidifies as it cools. The position of the print head relative to the substrate is then incremented along a z-axis (perpendicular to the x-y plane), and the process is repeated to form a shaped article resembling the digital representation. An example of an extrusion-based additive manufacturing system is Fused Filament Fabrication (“FFF”).

As another example, in a powder-based additive manufacturing system, a laser is used to locally sinter powder into a solid part. A shaped article is created by sequentially depositing a layer of powder followed by a laser pattern to sinter an image onto that layer. An example of a powder-based additive manufacturing system is Selective Laser Sintering (“SLS”).

As another example, shaped articles can be prepared using a continuous Fiber-Reinforced Thermoplastic (FRTP) printing method. This method is based on fused-deposition modeling and prints a combination of fibers and resins.

Accordingly, some embodiments include a method of making a shaped article comprising printing layers of the polymer composition to form the shaped article by an extrusion-based additive manufacturing system (for example FFF), a powder-based additive manufacturing system (for example SLS), or a continuous FRTP printing method.

Some embodiments include a filament including the polymer composition. Preferably, the filament is suitable for use in additive manufacturing methods as described above, such as FFF.

Should the disclosure of any patents, patent applications, and publications which are incorporated herein by reference conflict with the description of the present application to the extent that it may render a term unclear, the present description shall take precedence.

Exemplary embodiments will now be described in the following non-limiting examples.

### Examples

The thermal conductivity and mechanical properties were evaluated for various embodiments.

### Starting Materials

RYTON® PPS from Solvay Specialty Polymers USA, LLC.
Boron nitride, from Momentive Performance Materials Inc.
Zinc oxide (ZnO)) from DreyTek, Inc.
Magnesium oxide (MgO)) from Ube Material Industries, Ltd.
Glass Fibers from 3B-the fiberglass company.
Carbon Fibers from Solvay Cytec.
Toughener from Sumitomo Chemical.
Mold release agent, HDPE 6007G from Nexeo Plastics.

### Compounding of the Polymer Compositions

Each formulation was melt compounded using a 26 mm diameter Coperion® ZSK-26 co-rotating partially intermeshing twin screw extruder having an L/D ratio of 48:1. The barrel sections 2 through 12 and the die were heated to set point temperatures as follows: Barrels 2-6: 300° C.; Barrels 7-12: 300° C.; Die: 300° C.

In each case, the thermoplastic polymer(s) was/were fed at barrel section 1 using a gravimetric feeder at throughput rates in the range 30-35 lb/hr. The extruder was operated at screw speeds of around 200 RPM. Vacuum was applied at barrel zone 10 with a vacuum level of about 27 inches of mercury.

A single-hole die was used for all the polymer compositions to give a filament approximately 2.6 to 2.7 mm in diameter and the polymer filament exiting the die was cooled in water and fed to the pelletizer to generate pellets approximately 2.7 mm in length. Pellets were dried prior being injection molded into a sample in accordance with the test procedure to be applied to the sample.

### Evaluation of Mechanical Properties

The following ISO test methods were employed in evaluating the mechanical properties of the formulations:
Tensile properties: ISO 527
Flexural properties: ISO 178

Samples were prepared in accordance with the ISO procedure.

### Evaluation of Thermal Properties

Through-plane thermal conductivity was measured by the flash method according to ASTM E1461-13, “Standard Test Method for Thermal Diffusivity by the Flash Method.”

TABLE 1

| | C1 | C2 | C3 | E1 | C4 | C5 | C6 | E2 | C7 | C8 | C9 | E3 | C10 | C11 | E4 |
|---|---|---|---|---|---|---|---|---|---|---|---|---|---|---|---|
| PPS | 49.75 | 46.50 | 49.75 | 46.50 | 39.75 | 36.50 | 39.75 | 36.50 | 29.75 | 26.50 | 29.75 | 26.50 | 34.75 | 34.75 | 31.50 |
| Additive* | 0.25 | 0.25 | 0.25 | 0.25 | 0.25 | 0.25 | 0.25 | 0.25 | 0.25 | 0.25 | 0.25 | 0.25 | 0.25 | 0.25 | 0.25 |
| BN | 30.00 | 30.00 | 30.00 | 30.00 | 40.00 | 40.00 | 40.00 | 40.00 | 10.00 | 10.00 | 10.00 | 10.00 | 20.00 | 20.00 | 20.00 |
| Toughener | | 3.25 | | 3.25 | | 3.25 | | 3.25 | | 3.25 | | 3.25 | | | 3.25 |
| ZnO | | | | | | | | | | | | | 30 | 30 | 30 |
| MgO | | | | | | | | | 45.00 | 45.00 | 45.00 | 45.00 | | | |
| Glass Fiber | 20.00 | 20.00 | | | 20.00 | 20.00 | | | 15.00 | 15.00 | | | 15.00 | | |
| Carbon Fiber | | | 20.00 | 20.00 | | | 20.00 | 20.00 | | | 15.00 | 15.00 | | 15.00 | 15.00 |
| THERMAL | | | | | | | | | | | | | | | |
| CONDUCTIVITY | | | | | | | | | | | | | | | |
| Through Plane | 1.22 | 1.60 | 1.32 | 1.69 | 1.50 | 1.16 | 2.00 | 2.44 | 1.90 | 2.05 | 2.46 | 3.55 | 1.40 | 1.45 | 2.54 |
| (W/(m · K) | | | | | | | | | | | | | | | |
| ISO 527 TENSILE | | | | | | | | | | | | | | | |
| Modulus, GPa | 21 | 16 | 33 | 24 | 26 | 19 | 42 | 36 | 20 | 17 | 36 | 38 | 28 | 39 | 36 |
| Break Strain, % | 1.1 | 1.1 | 0.45 | 0.82 | 0.58 | 0.9 | 0.29 | 0.6 | 0.64 | 0.71 | 0.32 | 0.59 | 0.62 | 0.42 | 0.83 |
| % Δ** | | 0.00% | | 82.22% | | 55.17% | | 106.90% | | 10.94% | | 84.38% | | | 97.62% |
| ISO 178 | | | | | | | | | | | | | | | |
| FLEXURAL | | | | | | | | | | | | | | | |
| Modulus, GPa | 20 | 16 | 29 | 34 | 26 | 17 | 40 | 36 | 18 | 17 | 35 | 36 | 26 | 39 | 35 |
| Break Strain, % | 1.20 | 1.2 | 0.56 | 0.85 | 1.39 | 1.1 | 0.39 | 0.66 | 0.70 | 0.69 | 0.38 | 0.72 | 0.79 | 0.50 | 0.81 |
| % Δ** | | 0.00% | | 51.79% | | −20.86% | | 69.23% | | −1.45% | | 89.47% | | | 62.00% |

*Mold Release Agent
**(Value for formulation w/toughener − value for formulation w/out toughener)/Value for formulation w/out toughener) × 100

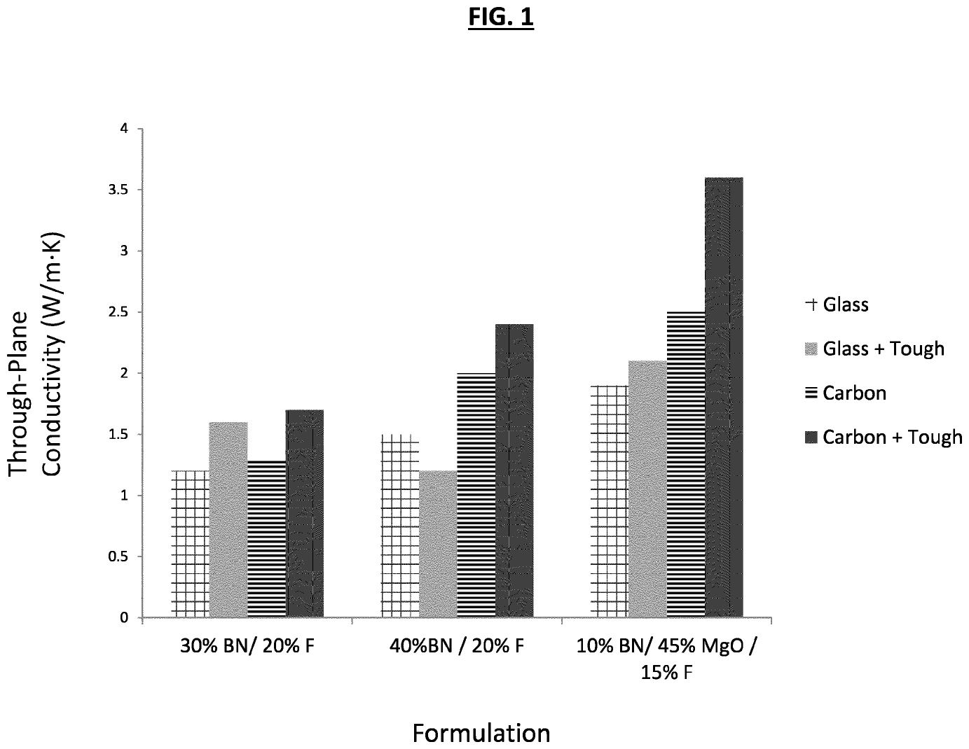

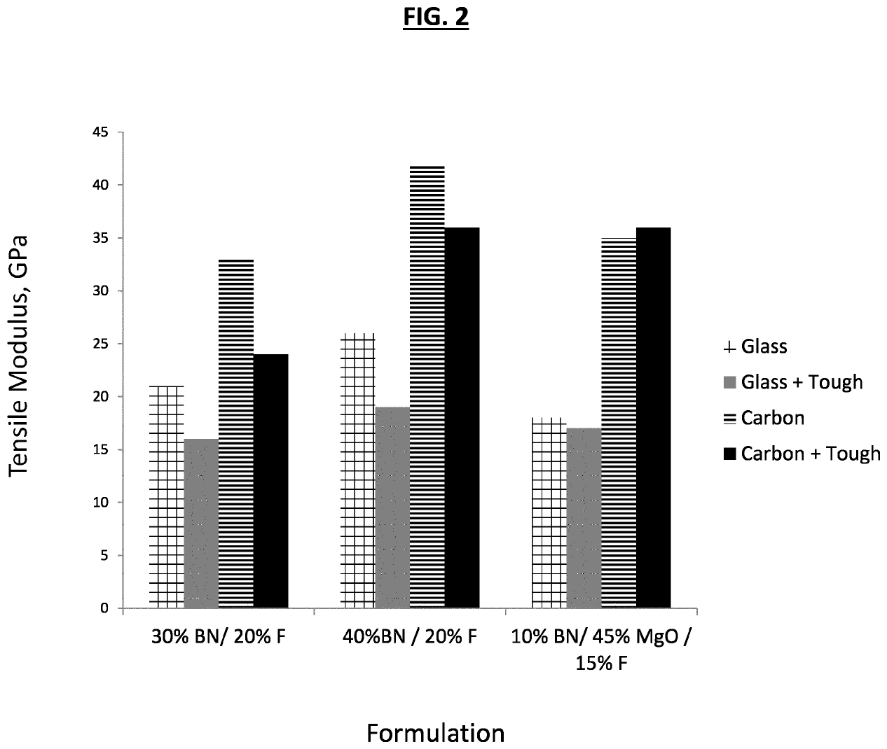

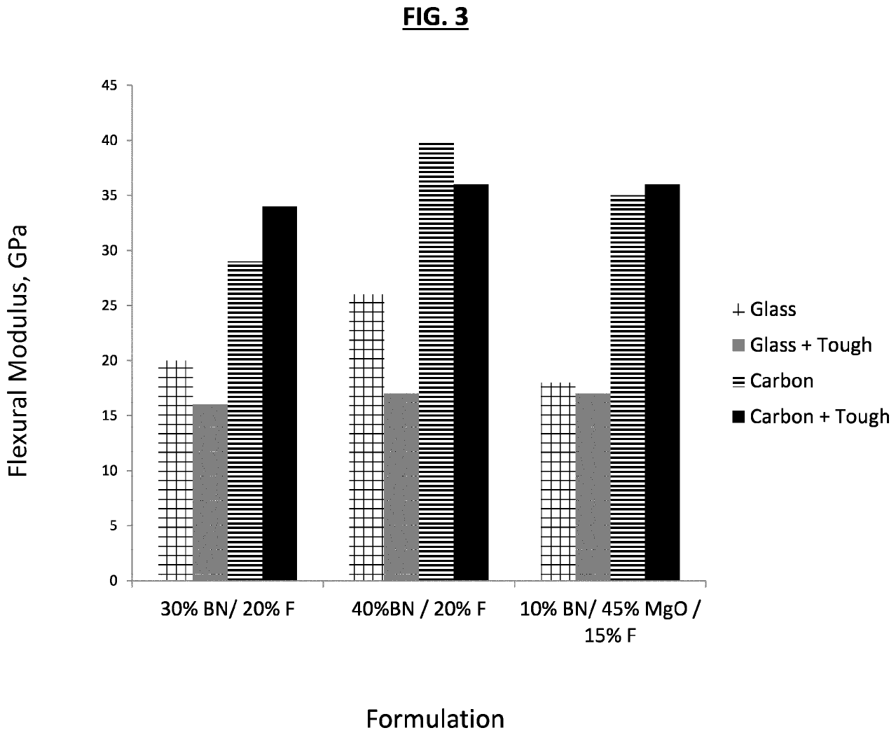

Table 1 shows the formulations prepared and data obtained relative thereto. Surprisingly and unexpectedly, and as also shown in FIG. 1, polymer compositions including a toughener and in which glass fibers were replaced with carbon fibers (Inventive Examples E1-E4) showed an increased through-plane thermal conductivity relative to the same compositions with glass fibers (Comparative Examples C1-C4). As shown in FIGS. 2 and 3, tensile and flexural moduli were substantially maintained.

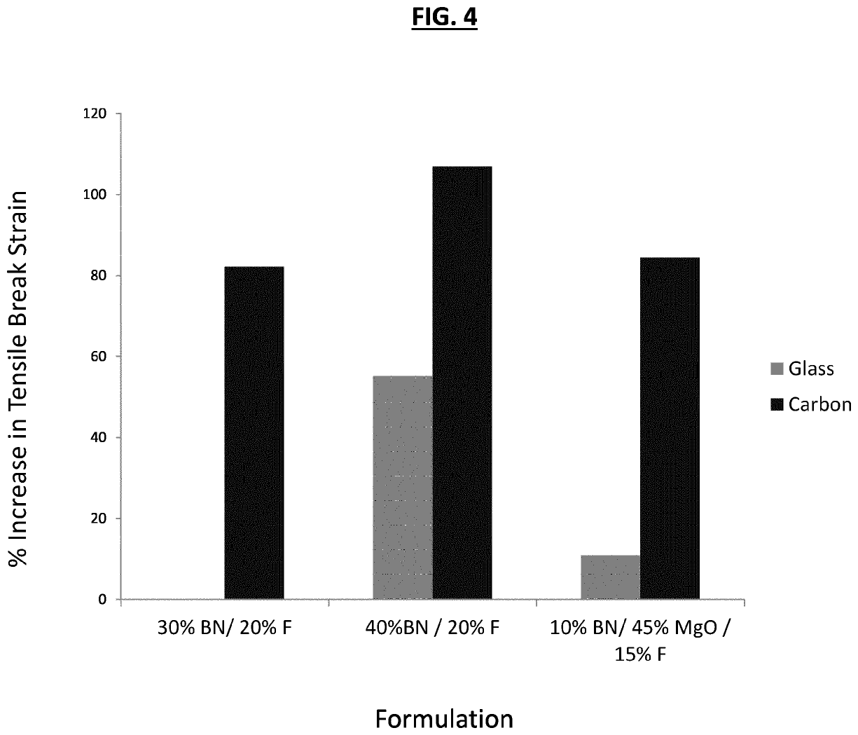

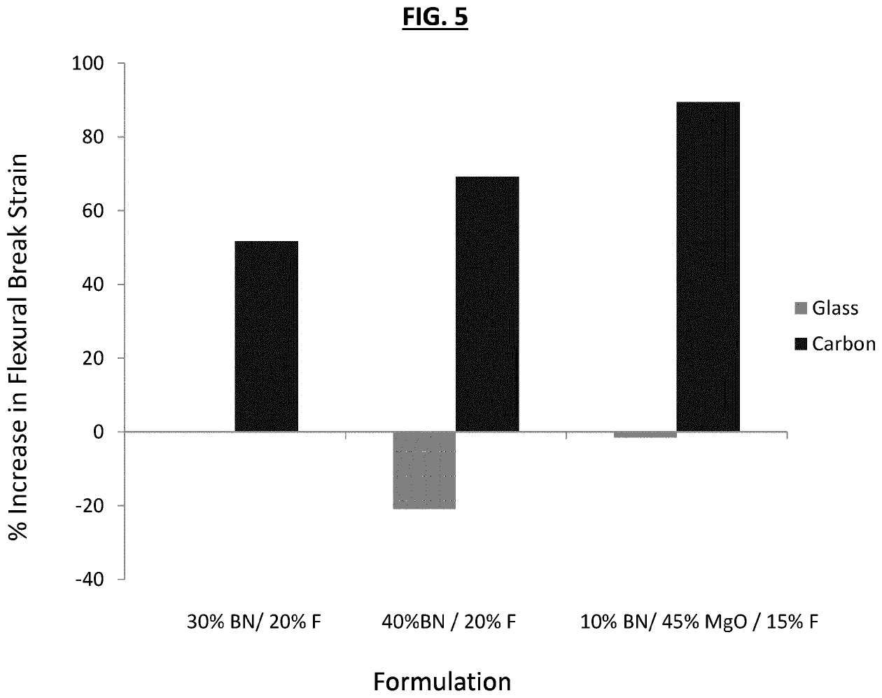

Further, the inventive polymer compositions (E1-E4) exhibited these surprising results while also exhibiting increases in elongation (tensile and flexural break strain %) relative to the same compositions without the toughener (C3, C6, C9 and C11, respectively). More surprisingly, and as shown in FIGS. 4 and 5, these increases in elongation were substantially greater than increases in elongation seen between analogous comparative samples, i.e., between samples having glass fibers and no toughener (C1, C4 and C7) and samples having glass fibers with toughener (C2, C5 and C8).

1. A polymer composition comprising:
from 25 to 50 wt. % of a thermoplastic polymer;
from 10 to 45 wt. % of a thermally conductive filler;
from 15 to 30 wt. % of a carbon fiber;
from 2 to 8 wt. % of a toughener; and
less than 5 wt. % additives;
wherein
wt. % is based on the total weight of the polymer composition,
the polymer composition is substantially free of glass fibers, and
the through-plane thermal conductivity of the polymer composition is at least 1.5 W/(m·K).

2. The polymer composition of claim 1, wherein the through-plane thermal conductivity of the polymer composition is at least 2 W/(m·K).

3. The polymer composition of any preceding claim, wherein the through-plane thermal conductivity of the polymer composition is at least 2.25 W/(m·K).

4. The polymer composition of any preceding claim, wherein the through-plane thermal conductivity of the polymer composition is at least 40% greater than an analogous polymer composition not comprising the toughener.

5. The polymer composition of any preceding claim, wherein the thermally conductive filler is an inorganic oxide or an inorganic nitride.

6. The polymer composition of any preceding claim, wherein the thermally conductive filler is boron nitride.

7. The polymer composition of any one of the preceding claims, wherein the thermoplastic polymer is selected from the group consisting of a poly(aryl sulfide), a polyamide, a poly(aryl ether sulfone), a poly(aryl ether ketone), a liquid crystal polymer, and a polyester.

8. The polymer composition of any one of the preceding claims, wherein the thermoplastic polymer is a poly(arylene sulfide).

9. The polymer composition of any one of the preceding claims, wherein the thermoplastic polymer is polyphenylene sulfide.

10. The polymer composition of any one of the preceding claims, wherein the thermoplastic polymer is a polyamide.

11. The polymer composition of any one of the preceding claims, wherein the toughener is selected from functionalized polymer backbones.

12. The polymer composition of claim 11, wherein the polymer backbone of the toughener is selected from elastomeric backbones comprising polyethylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

13. The polymers composition of claim 11 or 12, wherein the toughener is a functionalized tougheners selected from the group consisting of terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride. In some embodiments, the toughener is a terpolymer of ethylene, acrylic ester and glycidyl methacrylate, a copolymers of ethylene and butyl ester acrylate; and a copolymer of ethylene, butyl ester acrylate and glycidyl methacrylate.

14. An article comprising the polymer composition of any preceding claim.

15. The article of claim 14, wherein the article is selected from the group consisting of an electronic device, an automobile, a motor, a battery, an LED, an electronic board, an electronic vehicle charging station, a vacuum or vacuum system or a component of any of these.
